(19) United States
(12) Patent Application Publication
(10) Pub. No.: US 2008/0062634 A1
(43) Pub. Date: Mar. 13, 2008

(54) LOGICAL PARTITIONING OF DISK STORAGE ENCLOSURE

(75) Inventors: John C. Elliott, Tucson, AZ (US); Robert A. Kubo, Tucson, AZ (US); Gregg S. Lucas, Tucson, AZ (US)

Correspondence Address: LAW OFFICE OF DAN SHIFRIN, PC - IBM, 14081 WEST 59TH AVENUE, ARVADA, CO, 80004, US

(73) Assignee: INTERNATIONAL BUSINESS MACHINES CORPORATION, Armonk, NY (US)

(21) Appl. No.: 11/470,834

(22) Filed: Sep. 7, 2006

(51) Int. Cl. G06F 1/16

(52) U.S. Cl. 361/685

(57) ABSTRACT

A high density storage enclosure houses first and second pluralities of hard disk drives (HDDs). The enclosure may be partitioned into a plurality of virtual enclosures, the first plurality of HDDs being associated with a first virtual enclosure and the second plurality of HDDs being associated with a second virtual enclosure. Configuration of the storage enclosure is performed by an SES processor in the storage enclosure accessing configuration parameters received from an external configuration unit coupled to the storage enclosure. The virtual enclosures may be configured as two (or more) independent virtual enclosures on two (or more) independent fabric loops. Power supplies and cooling blowers in the storage enclosure may also be partitioned and assigned to be managed by SES processors in the virtual enclosures.

### RELATED APPLICATION DATA

The present application is related to commonly-assigned and co-pending U.S. application Ser. No. 11/______ [IBM Docket #TUC920060006US1], entitled ESTABLISHING COMMUNICATIONS ACROSS VIRTUAL ENCLOSURE BOUNDARIES, 11/______ [IBM Docket # TUC920060008US1], entitled FLEXIBLE DISK STORAGE ENCLOSURE, and Ser. No. 11/______ [IBM Docket # TUC920060009US1], entitled RECONFIGURABLE FC-AL STORAGE LOOPS IN A DATA STORAGE SYSTEM, filed on the filing date hereof, which applications are incorporated herein by reference in their entireties.

### TECHNICAL FIELD

The present invention relates generally to data storage enclosures and; in particular, to enabling legacy control software., originally designed for low density storage enclosures; to be used with more densely populated storage enclosures.

### BACKGROUND ART

FIG. 1 is a block diagram of a low density storage enclosure 100. The storage enclosure 100 includes a pair of redundant controller cards 110A, 110B, redundant power supplies 120A, 1208 and sixteen disk drive modules (DDMs, also referred to as storage drives., hard disk drives or HDDs) indicated generally as 130. The storage enclosure 100 also includes an enclosure midplane 140 and front and rear panels 150A, 150B. As illustrated in FIG. 2, each controller card 110A, 110B includes a switch 112A, 112B interconnected through the midplane to the storage drives 130, and a SCSI enclosure services (SES) processor 114A, 114B which manages various enclosure-related processes, such as power and cooling. Due to the interconnection through the midplane between the SES processors 114A, 114B, in the event that one of the controller cards 110A, 110B fails, the other SES processor may take over. FIG. 3 illustrates the interconnection of the power supplies 120A, 120B with the controller cards 110A, 110B and the DDMs 130 within the enclosure 100.

### SUMMARY OF THE INVENTION

When additional DDMs, such as another sixteen, are installed in the enclosure 100 software, firmware and microcode designed for a sixteen-drive enclosure may not be able to accommodate the increased density. To control development effort and resources it is desirable to preserve the existing software, firmware and microcode base with minimal changes, while increasing the storage device density per unit of rack space. A single mechanical enclosure package that can accommodate multiple instances of enclosure designs that preserves the existing software, firmware, and microcode base interfaces is therefore highly desirable.

The present invention provides a high density storage enclosure housing first and second pluralities of hard disk drives (HDDs). The enclosure may be partitioned into a plurality of virtual enclosures, the first plurality of HDDs being associated with a first virtual enclosure and the second plurality of HDDs being associated with a second virtual enclosure. Configuration of the storage enclosure is performed by an SES processor in the storage enclosure accessing configuration parameters received from an external configuration unit coupled to the storage enclosure. The virtual enclosures may be configured as two (or more) independent virtual enclosures on independent communication network fabric loops. Power supplies and cooling blowers in the storage enclosure may also be partitioned and assigned to be managed by SES processors in the virtual enclosures. A customer preferring the greater reliability of distributed storage may configure the storage enclosure as two (or more) virtual enclosures on independent communication network fabrics which may be coupled to separate control units.

### BRIEF DESCRIPTION OF THE DRAWINGS

FIG. 1 is a block diagram of a low density storage enclosure;

FIG. 2 is a block diagram illustrating interconnections of the controller cards of the storage enclosure of FIG. 1;

FIG. 3 is a block diagram illustrating the power distribution within the storage enclosure of FIG. 1;

FIGS. 4A, 4B, 4C illustrate front, rear and right side views, respectively, of a high density storage enclosure in which the present invention may be incorporated,

FIG. 5A is a block diagram of a flexible low- or high-density storage enclosure configurable as a single enclosure or as multiple virtual enclosures;

FIG. 5B is a block diagram of the flexible storage enclosure of FIG. 5A in a high-density configuration partitioned into two virtual enclosures on independent domains; and

FIGS. 6A and 6B illustrate a block diagram of the power distribution system of the high-density storage enclosure of FIG. 5B.

### DETAILED DESCRIPTION OF THE PREFERRED EMBODIMENT

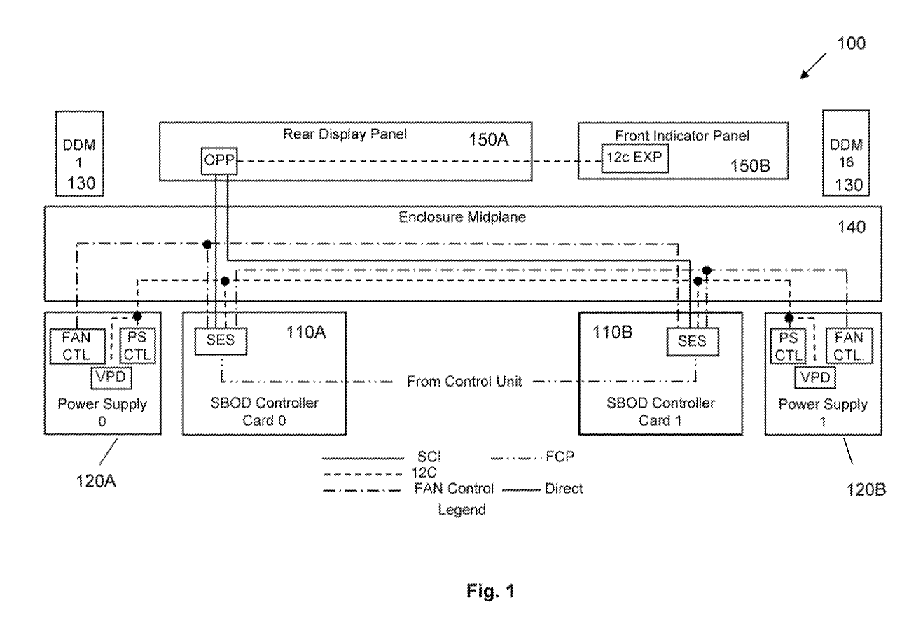

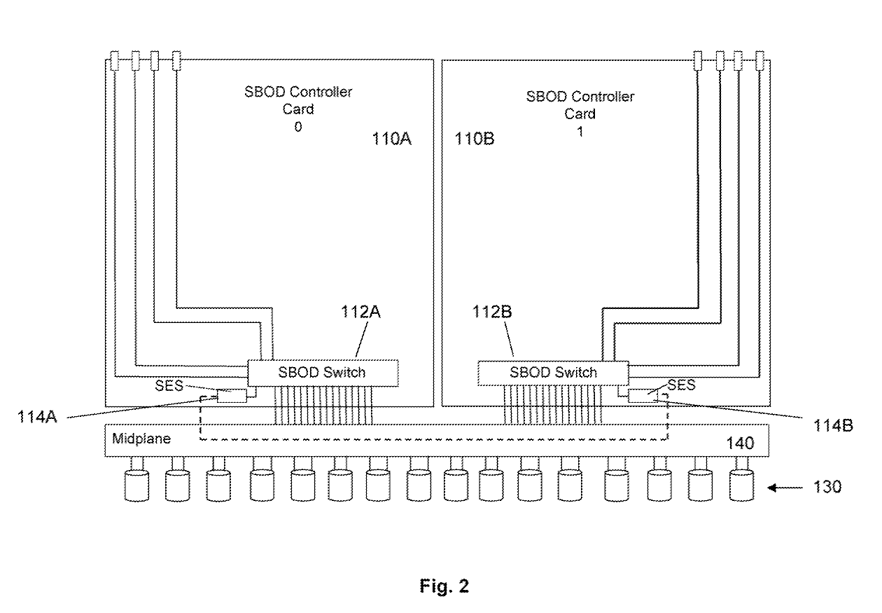

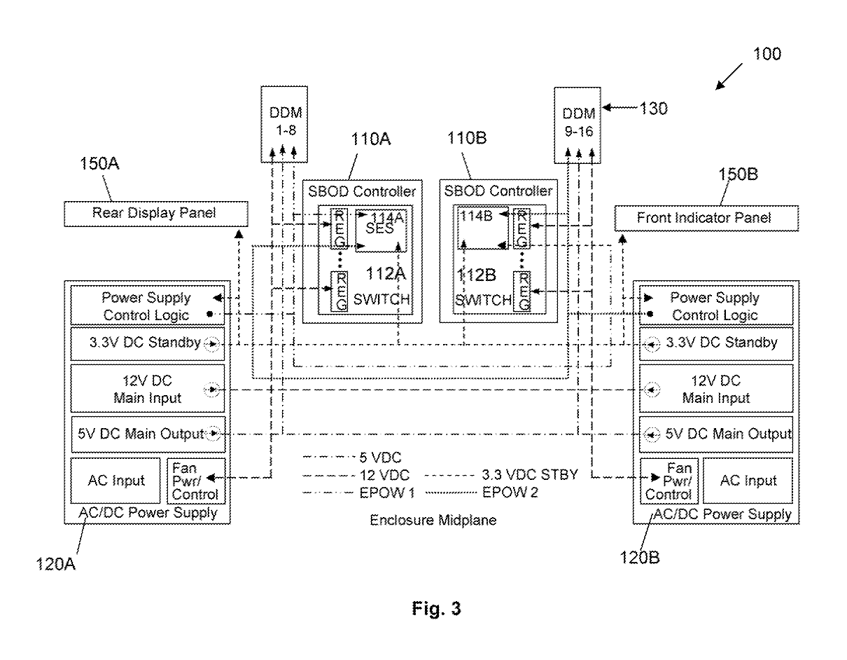

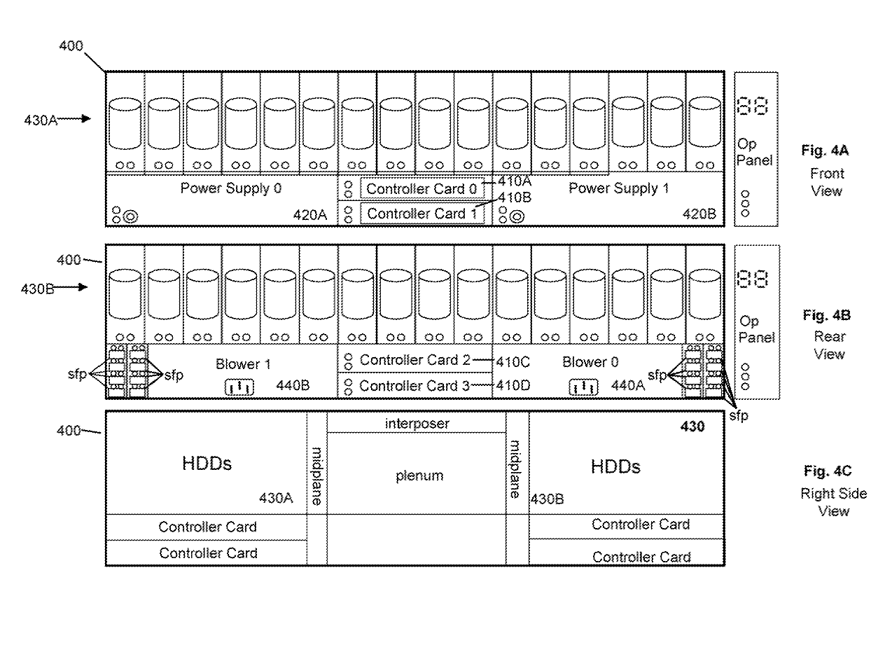

FIGS. 4A, 4B, 4C are representative front, rear and right side views, respectively, of a high density storage enclosure 400 in which thirty-two DDMs 430 have been installed, double the number in the enclosure of FIG. 1. In addition, the enclosure 400 includes two pairs of redundant controller cards 410A and 410B, 410C and 410D as well as a pairs of redundant power supplies 420A, 420B and blowers 440A, 440B. If desired, the enclosure 400 may be configured with a single instance of a storage enclosure (16 DDMs and a single pair of controller cards) by populating a single pair of controller cards in the enclosure and restricting the population of the DDMs to an appropriate placement within the enclosure.

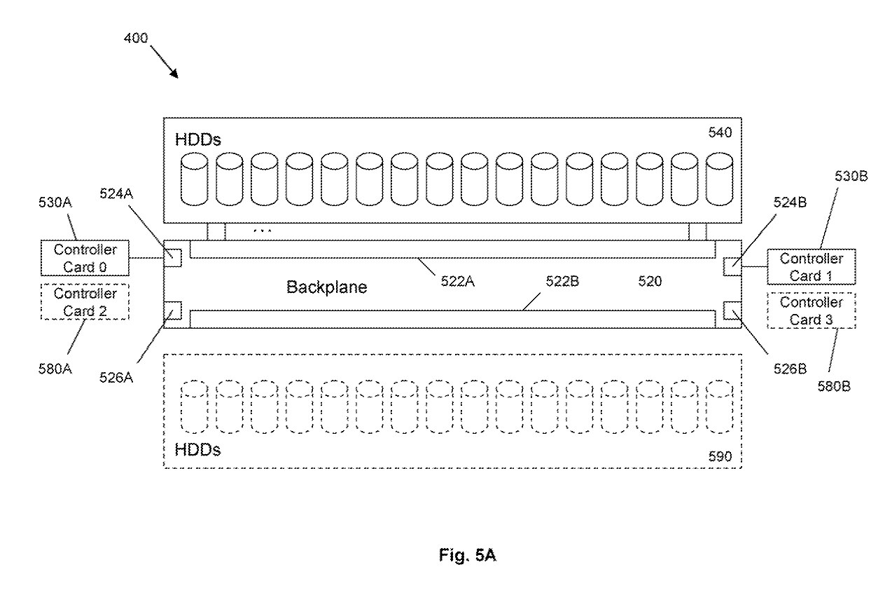

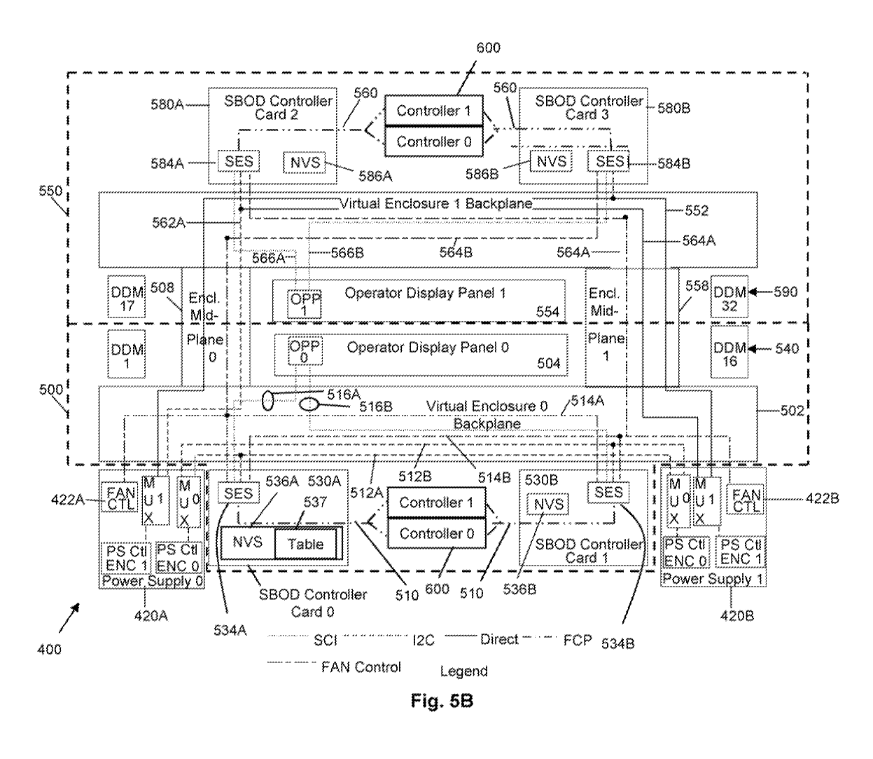

Implementing the present invention as illustrated in FIG. 5A a vendor may market a highly flexible storage enclosure, one which is configurable in a number of different ways. In one configuration, the enclosure 400 may be populated in a low density fashion, such as with up to sixteen drives 540 installed in drive connectors 522A on a backplane 520 and two redundant controller cards 530A, 530B installed in controller card connectors 524A, 524B on the backplane 520 in a second configuration, the enclosure 400 may be populated in a high density fashions such as with up to an additional sixteen drives 590 installed in drive connectors 522B and an additional pair of redundant controller cards 580A, 580B installed in card connectors 526A, 526B, configured as two virtual storage enclosures (as will be described with respect to FIG. 5B). In a third configuration, the enclosure 400 may be populated in a high density fashion, such as with thirty-two drives, but configured as a single storage enclosure.

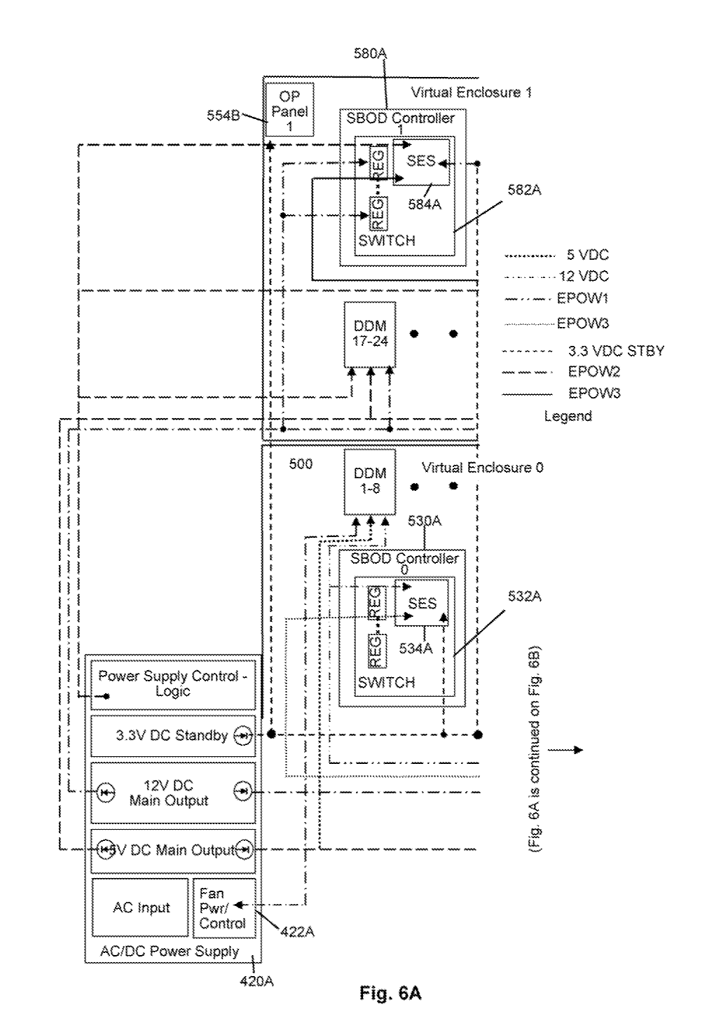

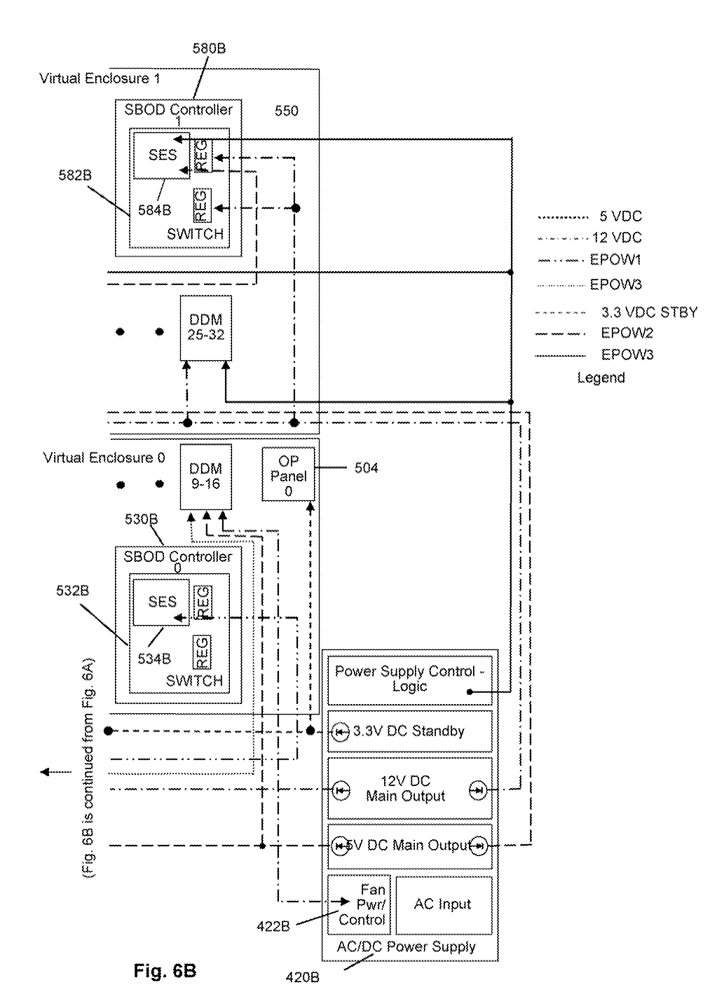

FIG. 58 is a block diagram of the storage enclosure 400 of FIG. 5A in a high-density configuration and partitioned into two virtual enclosures 500, 550. As will be described below, each power supply 420A, 420B may each be associated with one of the virtual enclosures although they are shared by both virtual enclosures 500, 550 for redundancy purposes. The first virtual enclosure 500 includes sixteen DDMs 540 and a redundant pair of controller cards 530A, 530B. Both controller cards 530A, 530B include a switch 532A, 532B (see FIGS. 6A, 6B), a SCSI enclosure services (SES) processor 534A, 5348 and associated memory, such as nonvolatile storage (NVS) 536A. 536B. The backplane 520 may be partitioned into two (or more) virtual backplanes 502, 552 as part of the two virtual enclosures 500, 550, respectively. One virtual backplane 502 interconnects the components of the first virtual enclosure 500 and an operator display panel 504 provides a display of the status of the enclosure 500. A path 510, such as a Fibre Channel/Arbitrated Loop (FC-AL) link, interconnects the two SES processors 534A, 534B with redundant external system control units (also known as system controllers) 600. Redundant paths 512A, 512B, such as an inter-IC (I²C) bus, provide control paths from each SES processor 534A, 5348 to each power supply 420A, 420B. Similarly, redundant paths 514A, 514B provide control paths from each SES processor 534A, 534B to a fan controller 422A, 422B in each power supply 420A, 420B. And, paths 516A, 516B interconnect each SES processor 534A, 534B with the first operator display panel 504.

Similarly, the second virtual enclosure 550 includes sixteen DDMs 590 and a redundant pair of controller cards 580A, 580B. Both controller cards 580A, 580B include a switch 582A, 582B (see FIGS. 6A, 6B), an SES processor 584A, 584B and associated memory, such as NVS 586A, 586B. The second virtual backplane 552 interconnects the components of the second virtual enclosure 550 and an operator display panel 554 provides a display of the status of the enclosure 550. A path 560, such as an FC-AL link, interconnects the two SES processors 584A, 584B with the external system control units 600. Redundant paths 562A, 562B, such as an I²C bus, provide control paths from each SES processor 584A, 584B to each power supply 420A, 420B Similarly, redundant paths 564A, 564B provide control paths from each SES processor 584A, 584B to a fan controller 422A, 422B in each power supply 420A, 420B. And, paths 566A, 566B interconnect each SES processor 584A, 584B with the second operator display panel 554.

Virtual enclosure midplanes 508, 558 interconnect the backplanes 502, 552 of the two virtual enclosures 500, 550. Thus, the logical partitioning of the physical enclosures provides each of the two virtual enclosures 500, 550 with the disk fabric loop or network interconnections that they would have in the single enclosure design of FIG. 1. It will be appreciated that the physical enclosure may be configured as more than two virtual enclosures within the scope of the present invention.

The controlling software, firmware or microcode is substantially the same with any of the three arrangements. The enclosure configuration may be performed when the enclosure 400 is installed or modified in a customer's facility. The SES processors 534A, 534B, 584A, 584B are coupled to a configuration unit 600 via the lines 510, 560 (FIG. 5B) One of the virtual enclosures, such as the first enclosure 500, is designated as the master enclosure and one of the SES processors in the master enclosure, such as processor 534A, is designated as the master processor (although the other SES processor 534B may instead be designated as the master). Nonvolatile storage 536A associated with the master processor 534A stores an SES table 537 into which parameters are loaded from the configuration unit to define the enclosure configuration. The table 537 is then accessed by the master processor 534A and enables and disables links within the physical enclosure 400 to configure the enclosure 400 with a single instance of a storage enclosure or with multiple virtual enclosures.

FIGS. 6A and 6B are a block diagram of the distribution of power from the power supplies 420A, 420B to the various components of the two virtual enclosures 500, 550. As with the disk fabric network interconnections, the logical partitioning of the physical enclosures provided each of the two virtual enclosures 500, 550 with the power distribution and control functions that they would have in the single enclosure design of FIG. 1. According to the present invention, the first power supply 420A and first blower 440A (FIG. 4B) and the second power supply 420B and second blower 4408 (FIG. 4B) each have redundant, independently controlled power outputs for the virtual enclosures 500 and 550. When the system is configured as a single unit the outputs are coordinated as a single redundant power system. When configured as virtual enclosures, the outputs are controlled to allow an SES processor in each enclosure instance to manage the outputs as a separate redundant power system for each one. In this latter configuration, the SES processors 534A, 534B in the first virtual enclosure 500 may manage, separately or together, a first power/blower function (one output from each of the two power supplies 420A, 420B) for the first virtual enclosure 500 and the SES processors 584A, 548B in the second virtual enclosure 550 may manage, separately or together, a second power/blower function (the other output from each of the two power supplies 420A, 420B) for the second virtual enclosure 550. The management of the power supply/blower function of the virtual enclosures 500, 550 may be configured in other ways, as well.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and COD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. For example, certain components have been described as being coupled to a backplane and other components as being coupled to a mid-plane. However, such description is not intended to limit components to being coupled to either a backplane or to a mid-plane. Rather, either a backplane and a mid-plane may used and both may be generically labeled as a “connector plane.” Moreover, although described above with respect to methods and systems, the need in the art may also be met with a computer program product containing instructions for logically partitioning disk storage enclosures or a method for deploying computing infrastructure comprising integrating computer readable code into a computing system for logically partitioning disk storage enclosures.

What is claimed is:

1. A high density data storage enclosure, comprising:
an enclosure midplane;
a first plurality of hard disk drives (HDDs), each first HDD coupled to the enclosure midplane,
a second plurality of HDDs, each second HDD coupled to the enclosure midplane;
a first pair of redundant controller cards associated with the first plurality of HDDs, comprising:
a first controller card comprising a first switch coupled to the enclosure midplane and a first SCSI enclosure services (SES) processor coupled to the first switch, and
a second controller card comprising a second switch coupled to the enclosure midplane and a second SES processor coupled to the second switch;
a second pair of redundant controller cards associated with the second plurality of HDDs, comprising:
a third controller card comprising a third switch coupled to the enclosure midplane and a third SES processor coupled to the third switch, and
a fourth controller card comprising a fourth switch coupled to the enclosure midplane and a fourth SES processor coupled to the fourth switch;
means for partitioning the storage enclosure into a plurality of virtual enclosures, wherein the virtual enclosures comprise:
a first virtual enclosure comprising,
the first and second controller cards,
a first virtual midplane partitioned from the enclosure midplane and to which the first and second controller cards are coupled, the first virtual midplane including a path through which the first and second SES processors are coupled; and
the first plurality of HDDs; and
a second virtual enclosure comprising:
the third and fourth controller cards;
a second virtual midplane partitioned from the enclosure midplane and to which the third and fourth controller cards are coupled, the second virtual midplane including a path through which the third and fourth SES processors are coupled; and
the second plurality of HDDs.

2. The high density data storage enclosure of claim 1, wherein the paths through which the first and second SES processors are coupled and through which the third and fourth SES processors are coupled comprise a Fibre Channel link.

3. The high density data storage enclosure of claim 1, wherein the partitioning means comprises,
an interface to couple a selected one of the first, second, third and fourth SES processors with an external configuration unit;
a non-volatile storage (NVS) unit associated with the selected SES processor; and
a table stored in the NVS unit, into which configuration parameters, defining an enclosure configuration, are loadable from the external configuration unit; and
the selected SES processor operable to access the table and, in response to the configuration parameters, enable and disable paths within the storage enclosure to partition the storage enclosure.

4. The high density data storage enclosure of claim 1 further comprising,
a redundant first power/blower functions comprising a first of redundant power outputs of first and second power supplies and managed by the first and second SES processors for the first virtual enclosure; and
a redundant second power/blower function, comprising a second of the redundant power outputs and managed by the third and fourth SES processors for the second virtual enclosure,

5. The high density data storage enclosure of claim 1, wherein the first and second virtual enclosures are configured as two independent virtual enclosures on two independent fabric loops.

6. A method for managing a high density data storage enclosure having first and second pluralities of hard disk drives (HDDs), each plurality coupled to an enclosure connector plane, comprising,
receiving configuration instructions from an external configuration unit;
in response to the configuration instructions, configuring a first virtual enclosure to include the first plurality of HDDs; and
in further response to the configuration instructions, configuring a second virtual enclosure to include the second plurality of HDDs.

7. The method of claim 6, further comprising storing configuration parameters associated with the received configuration instructions in a table accessible by an SES processor in the storage enclosure.

8. The method of claim 6, wherein configuring the first and second virtual enclosures comprises enabling and disabling paths within the storage enclosure to partition the storage enclosure into the first and second virtual enclosures.

9. The method of claim 6, further comprising,
managing a first power/blower function, comprising a first of redundant power outputs of first and second power supplies, by the first and second SES processors for the first virtual enclosure; and
managing a second power/blower function, comprising a second of the redundant power outputs, by the third and fourth SES processors for the second virtual enclosure.

10. The method of claim 6, wherein configuring the first and second virtual enclosures comprises configuring the first and second virtual enclosures as two independent virtual enclosures on two independent fabric loops.

11. A computer program product of a computer readable medium usable with a programmable computer, the computer program product having computer-readable code embodied therein for managing a high density data storage enclosure having first and second pluralities of hard disk drives (HDDs), each plurality coupled to an enclosure connector plane, the computer-readable code comprising instructions for,
receiving configuration instructions from an external configuration unit;
in response to the configuration instructions, configuring a first virtual enclosure to include the first plurality of HDDs; and
in further response to the configuration instructions, configuring a second virtual enclosure to include the second plurality of HDDs.

12. The computer program product of claim 11, the computer-readable code further comprising instructions for storing configuration parameters associated with the received configuration instructions in a table accessible by an SES processor in the storage enclosure.

13. The computer program product of claim 11, wherein the instructions for configuring the first and second virtual enclosures comprise the instructions enabling and disabling paths within the storage enclosure to partition the storage enclosure into the first and second virtual enclosures.

14. The computer program product of claim 11, the computer-readable code further comprising instructions for
managing a first power/blower function, comprising a first of redundant power outputs of first and second power supplies, by the first and second SES processors for the first virtual enclosure, and
managing a second power/blower function, comprising a second of the redundant power outputs, by the third and fourth SES processors for the second virtual enclosure.

15. The computer program product of claim 11, wherein the instructions for configuring the first and second virtual enclosures comprise instructions for configuring the first and second virtual enclosures as two independent virtual enclosures on two independent fabric loops.

16. A high density data storage enclosure having first and second pluralities of hard disk drives (HDDs), each plurality coupled to an enclosure connector plane, comprising:
a memory for storing configuration instructions received from an external configuration unit;
a first virtual enclosure configured, in response to the configuration instructions, to include the first plurality of HDDs, and
a second virtual enclosure configured, in further response to the configuration instructions, to include the second plurality of HDDs,

17. The storage enclosure of claim 16, wherein the first and second virtual enclosures are configured as two independent virtual enclosures on two independent fabric loops.
